(19) United States
(12) Patent Application Publication
(10) Pub. No.: US 2020/0104479 A1
(43) Pub. Date: Apr. 2, 2020

(54) ELECTRONIC DEVICE PASSCODE RECOMMENDATION USING ON-DEVICE INFORMATION

(71) Applicant: Apple Inc., Cupertino, CA (US)

(72) Inventors: Ritwik K. Kumar, San Jose, CA (US); Eric D. Friedman, Berkeley, CA (US)

(21) Appl. No.: 16/405,399

(22) Filed: May 7, 2019

Related U.S. Application Data
(60) Provisional application No. 62/738,698, filed on Sep. 28, 2018.

(51) Int. Cl. G06F 21/45; G06N 20/00

(52) U.S. Cl. CPC G06F 21/45; G06N 20/00

(57) ABSTRACT

Systems, methods, and computer-readable media for recommending passcodes for an electronic device using information local to the electronic device are provided. Such local information may be unique to a particular device and/or to a particular device user, such as unique data from one or more device applications, including, but not limited to, a calendar application, a media library application, and a contacts application.

### CROSS-REFERENCE TO RELATED APPLICATION(S)

This application claims the benefit of prior filed U.S. Provisional Patent Application No. 62/738,698, filed Sep. 28, 2018, which is hereby incorporated by reference herein in its entirety.

### TECHNICAL FIELD

This disclosure relates to the recommendation of passcodes and, more particularly, to the recommendation of passcodes for an electronic device using information local to the electronic device.

### BACKGROUND OF THE DISCLOSURE

Electronic devices (e.g., cellular telephones) may be provided with various valuable resources, such as a calendar application, a payment application, and an entire operating system application. Often times, access to one or more of these resources may be protected by a passcode that must be entered by a user for authenticating him or herself before such access is granted. However, users often use passcodes that are weak or difficult to remember.

### SUMMARY OF THE DISCLOSURE

This document describes systems, methods, and computer-readable media for recommending passcodes for an electronic device using information local to the electronic device.

As an example, a method is provided for managing security of an electronic device that includes an output component, a memory component storing a plurality of information elements of at least one data source, and a processor communicatively coupled to each one of the output component and the memory component. The method may include using the processor for selecting a passcode, selecting a learning technique, determining a framework for the selected passcode using the selected learning technique, obtaining at least a subset of the plurality of information elements, defining a mnemonic for the selected passcode by satisfying the determined framework using at least one information element from the obtained subset, and presenting a passcode recommendation including a representation of the defined mnemonic to a user of the electronic device via the output component.

As another example, a method is provided for managing security of an electronic device that includes a processor and a memory component storing a plurality of media items operative to be played back by the processor. The method may include using the processor for determining a framework for a passcode using a learning technique and defining a mnemonic for the passcode by satisfying the framework using at least a portion of text metadata associated with at least one media item of the plurality of media items.

As yet another example, a method is provided for managing security of an electronic device that includes a processor and a memory component storing a plurality of information elements of at least one data source. The method may include using the processor for defining a mnemonic using at least one information element from the plurality of information elements, selecting a learning technique, and determining a passcode based on the defined mnemonic and the selected learning technique.

This Summary is provided only to summarize some example embodiments, so as to provide a basic understanding of some aspects of the subject matter described in this document. Accordingly, it will be appreciated that the features described in this Summary are only examples and should not be construed to narrow the scope or spirit of the subject matter described herein in any way. Unless otherwise stated, features described in the context of one example may be combined or used with features described in the context of one or more other examples. Other features, aspects, and advantages of the subject matter described herein will become apparent from the following Detailed Description, Figures, and Claims.

### BRIEF DESCRIPTION OF THE DRAWINGS

The discussion below makes reference to the following drawings, in which like reference characters may refer to like parts throughout, and in which:

FIG. 1 is a schematic view of an illustrative electronic device for recommending passcodes;

FIG. 2 is a front view of an illustrative example of the electronic device of FIG. 1;

FIGS. 2A-2E are front views of exemplary screens of a graphical user interface of the electronic device of FIGS. 1 and 2 illustrating processes for recommending passcodes; and

FIG. 3 is a flowchart of an illustrative process for recommending passcodes.

### DETAILED DESCRIPTION OF THE DISCLOSURE

Systems, methods, and computer-readable media may be provided for recommending passcodes for an electronic device using information local to the electronic device (e.g., when a user has explicitly opted-in to such a service), where such local information may be unique to a particular device and/or to a particular device user, such as unique data from one or more device applications, including, but not limited to, a calendar application, a media library application, a contacts application, a shortcuts or bookmarks application (e.g., a browsing history or saved bookmarks to certain online sites or the like), and/or the like. Various processes may be carried out for selecting an appropriate passcode and defining one or more mnemonics for that passcode using such local information. This may facilitate user memorization of a recommended strong (e.g., non-user generated) passcode that may be triggered based on one or more mnemonics of the recommendation that may be generated using suitable learning techniques and local information that may be uniquely identifiable or otherwise meaningful to the user to aid in the user's memorization process. The processes for generating such mnemonics for passcode recommendations may be carried out entirely locally on the electronic device, not only for protecting the privacy of the user's on-device information but also for protecting the passcodes and any associated hint information (e.g., mnemonics, learning techniques, etc.).

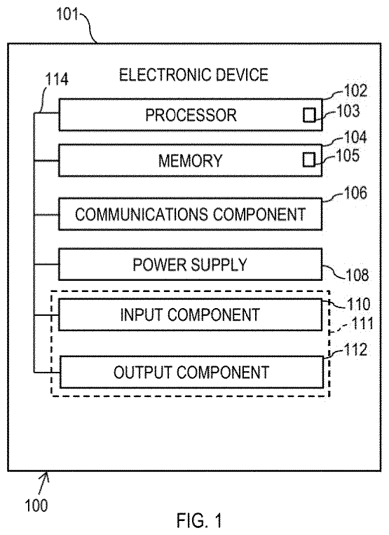

FIG. 1 is a schematic view of an illustrative electronic device 100 on which passcodes may be recommended in accordance with some embodiments. Electronic device 100 can include, but is not limited to, a music player (e.g., an iPod™ available by Apple Inc. of Cupertino, Calif.), video player, still image player, game player, other media player, music recorder, movie or video camera or recorder, still camera, other media recorder, radio, medical equipment, domestic appliance, transportation vehicle instrument, musical instrument, calculator, cellular telephone (e.g., an iPhone™ available by Apple Inc.), other wireless communication device, personal digital assistant, remote control, pager, computer (e.g., a desktop, laptop, tablet (e.g., an iPad™ available by Apple Inc.), server, etc.), monitor, television, stereo equipment, set up box, set-top box, boom box, modem, router, printer, or any combination thereof. Electronic device 100 may be any portable, mobile, hand-held, or miniature electronic device that may be configured to recommend passcodes wherever a user travels. Some miniature electronic devices may have a form factor that is smaller than that of hand-held electronic devices, such as an iPhone™. Illustrative miniature electronic devices can be integrated into various objects that may include, but are not limited to, watches (e.g., an Apple Watch™ available by Apple Inc.), rings, necklaces, belts, accessories for belts, headsets, accessories for shoes, virtual reality devices, glasses, other wearable electronics, accessories for sporting equipment, accessories for fitness equipment, key chains, or any combination thereof Alternatively, electronic device 100 may not be portable at all, but may instead be generally stationary.

As shown in FIG. 1, for example, electronic device 100 may include a processor 102, memory 104, communications component 106, power supply 108, input component 110, and output component 112. Electronic device 100 may also include a bus 114 that may provide one or more wired or wireless communication links or paths for transferring data and/or power to, from, or between various other components of device 100. In some embodiments, one or more components of electronic device 100 may be combined or omitted. Moreover, electronic device 100 may include other components not combined or included in FIG. 1, or several instances of the components shown in FIG. 1 may be provided by device 100. For the sake of simplicity, only one of each of the components is shown in FIG. 1.

Memory 104 may include one or more storage mediums, including for example, a hard-drive, flash memory, permanent memory such as read-only memory (“ROM”), semi-permanent memory such as random access memory (“RAM”), any other suitable type of storage component, or any combination thereof Memory 104 may include cache memory, which may be one or more different types of memory used for temporarily storing data for electronic device applications. Memory 104 may be fixedly embedded within electronic device 100 or may be incorporated onto one or more suitable types of cards that may be repeatedly inserted into and removed from electronic device 100 (e.g., a subscriber identity module (“SIM”) card or secure digital (“SD”) memory card). Memory 104 may store media data (e.g., music and image files), software (e.g., for implementing passcode recommendation functions on device 100 and/or storing passcodes for user authentication), firmware, preference information (e.g., media playback preferences), lifestyle information (e.g., food preferences), health or exercise information (e.g., information obtained by exercise monitoring equipment), wallet or transaction information (e.g., information such as credit card information), wireless connection information (e.g., information that may enable device 100 to establish a wireless connection), subscription information (e.g., information that keeps track of podcasts or television shows or other media a user subscribes to), media information (e.g., media item names, playback counts, playlists, various media metadata, etc.), contact information (e.g., names, telephone numbers, e-mail addresses, mailing addresses, birthdays, etc.), calendar information (e.g., event type and location and time information), any other suitable data, or any combination thereof.

Communications component 106 may be provided to allow device 100 to communicate with one or more other electronic devices or servers using any suitable communications protocol. For example, communications component 106 may support Wi-Fi (e.g., an 802.11 protocol), ZigBee (e.g., an 802.15.4 protocol), WiDi™, Ethernet, Bluetooth™, Bluetooth™ Low Energy (“BLE”), high frequency systems (e.g., 900 MHz, 2.4 GHz, and 5.6 GHz communication systems), infrared, transmission control protocol/internet protocol (“TCP/IP”) (e.g., any of the protocols used in each of the TCP/IP layers), Stream Control Transmission Protocol (“SCTP”), Dynamic Host Configuration Protocol (“DHCP”), hypertext transfer protocol (“HTTP”), BitTorrent™, file transfer protocol (“FTP”), real-time transport protocol (“RTP”), real-time streaming protocol (“RTSP”), real-time control protocol (“RTCP”), Remote Audio Output Protocol (“RAOP”), Real Data Transport Protocol™ (“RDTP”), User Datagram Protocol (“UDP”), secure shell protocol (“SSH”), wireless distribution system (“WDS”) bridging, any communications protocol that may be used by wireless and cellular telephones and personal e-mail devices (e.g., Global System for Mobile Communications (“GSM”), GSM plus Enhanced Data rates for GSM Evolution (“EDGE”), Code Division Multiple Access (“CDMA”), Orthogonal Frequency-Division Multiple Access (“OFDMA”), high speed packet access (“HSPA”), multi-band, etc.), any communications protocol that may be used by a low power Wireless Personal Area Network (“6LoWPAN”) module, any suitable cellular communications protocol (e.g., broadband cellular network technologies (e.g., 3G, 4G, 5G, etc.)), any other communications protocol, or any combination thereof. Communications component 106 may also include or be electrically coupled to any suitable transceiver circuitry (e.g., via bus 114) that can enable device 100 to be communicatively coupled to another device (e.g., a host computer or an accessory device or remote server or any other suitable remote device) and communicate with that other device wirelessly, or via a wired connection (e.g., using a connector port). Communications component 106 may be configured to determine a geographical position of electronic device 100. For example, communications component 106 may utilize the global positioning system (“GPS”) or a regional or site-wide positioning system that may use cell tower positioning technology or Wi-Fi technology.

Power supply 108 can include any suitable circuitry for receiving and/or generating power, and for providing such power to one or more of the other components of electronic device 100. For example, power supply 108 can be coupled to a power grid (e.g., when device 100 is not acting as a portable device or when a battery of the device is being charged at an electrical outlet with power generated by an electrical power plant). As another example, power supply 108 can be configured to generate power from a natural source (e.g., solar power using solar cells). As another example, power supply 108 can include one or more batteries for providing power (e.g., when device 100 is acting as a portable device).

One or more input components 110 may be provided to permit a device user or device environment to interact or interface with device 100. For example, input component 110 can take a variety of forms, including, but not limited to, a touch pad, dial, click wheel, scroll wheel, touch screen, one or more buttons (e.g., a keyboard), mouse, joy stick, track ball, microphone, camera, scanner (e.g., a bar code scanner or any other suitable scanner that may obtain product identifying information from a code, such as a bar code, a QR code, or the like), proximity sensor, light detector, motion sensor, biometric sensor (e.g., a fingerprint reader or other feature recognition sensor, which may operate in conjunction with a feature-processing application that may be accessible to electronic device 100 for authenticating a user), input ports or connectors, and combinations thereof. Each input component 110 can be configured to provide one or more dedicated control functions for making selections or issuing commands associated with operating device 100.

Electronic device 100 may also include one or more output components 112 that may present information (e.g., graphical, audible, and/or tactile information) to a user of device 100. For example, output component 112 of electronic device 100 may take various forms, including, but not limited to, audio speakers, headphones, audio line-outs, visual displays, antennas, infrared ports, rumblers, vibrators, any other suitable haptic elements, or combinations thereof.

It should be noted that one or more input components and one or more output components may sometimes be referred to collectively herein as an input/output (“I/O”) component or I/O interface (e.g., input component 110 and output component 112 as I/O component or I/O interface). For example, input component 110 and output component 112 may sometimes be a single I/O component 111, such as a touch screen, that may receive input information through a user's touch of a display screen and that may also provide visual information to a user via that same display screen.

Processor 102 of electronic device 100 may include any processing circuitry that may be operative to control the operations and performance of one or more components of electronic device 100. For example, processor 102 may receive input signals from input component 110 and/or drive output signals through output component 112. As shown in FIG. 1, processor 102 may be used to run one or more applications, such as an application 103. Application 103 may include, but is not limited to, one or more operating system applications, firmware applications, media playback applications, media editing applications, passcode recommendation and/or management applications, biometric feature-processing applications, or any other suitable applications. For example, processor 102 may load application 103 as a user interface program to determine how instructions or data received via an input component 110 or other component of device 100 may manipulate the way in which information may be stored and/or provided to the user via an output component 112 or other component of device 100. Application 103 may be accessed by processor 102 from any suitable source, such as from memory 104 (e.g., via bus 114) or from another device or server (e.g., via communications component 106). Processor 102 may include a single processor or multiple processors. For example, processor 102 may include at least one “general purpose” microprocessor, a combination of general and special purpose microprocessors, instruction set processors, graphics processors, video processors, and/or related chips sets, and/or special purpose microprocessors. Processor 102 also may include on board memory for caching purposes.

Electronic device 100 may also be provided with a housing 101 that may at least partially enclose one or more of the components of device 100 for protection from debris and other degrading forces external to device 100. In some embodiments, one or more of the components may be provided within its own housing (e.g., input component 110 may be an independent keyboard or mouse within its own housing that may wirelessly or through a wire communicate with processor 102, which may be provided within its own housing).

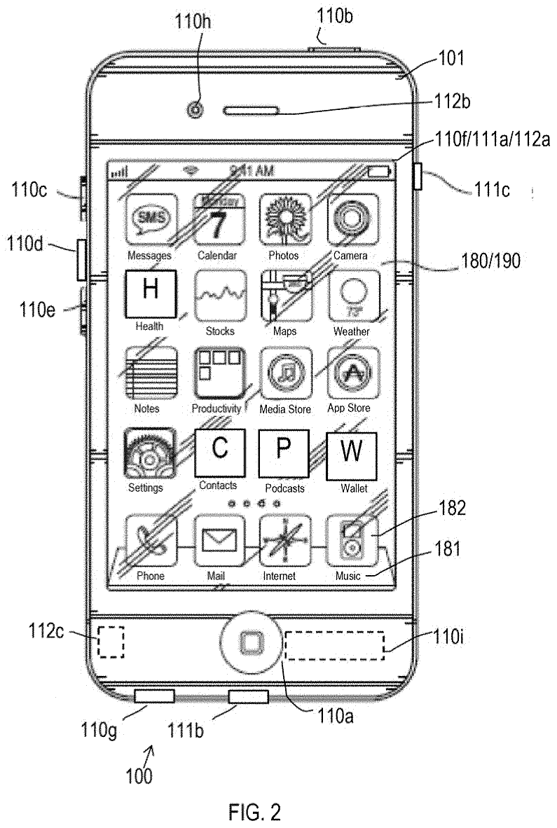

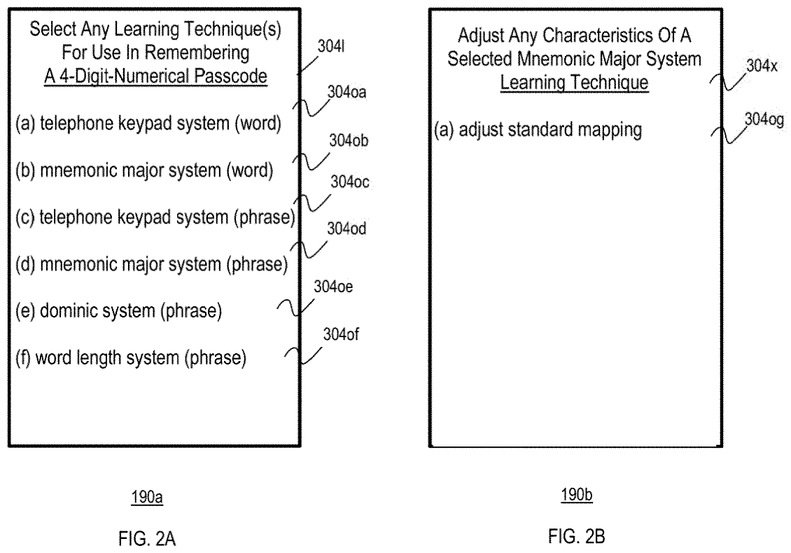

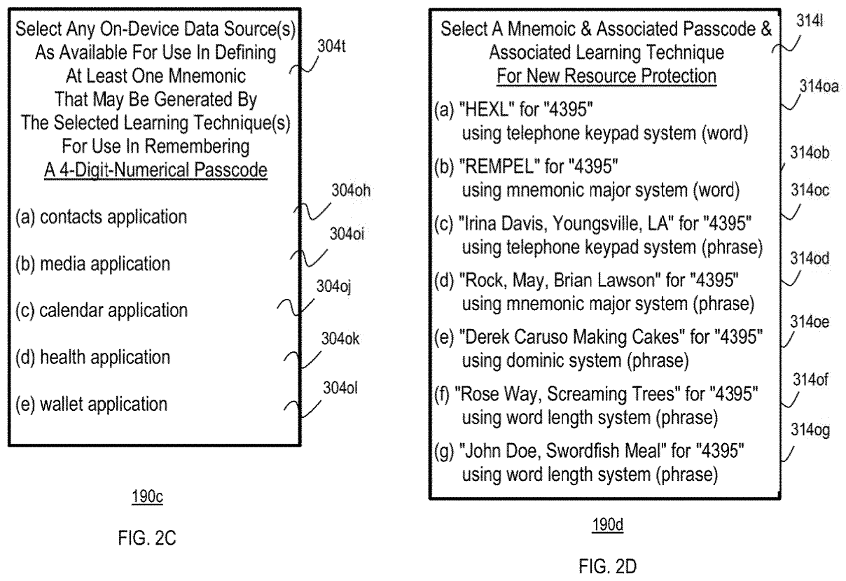

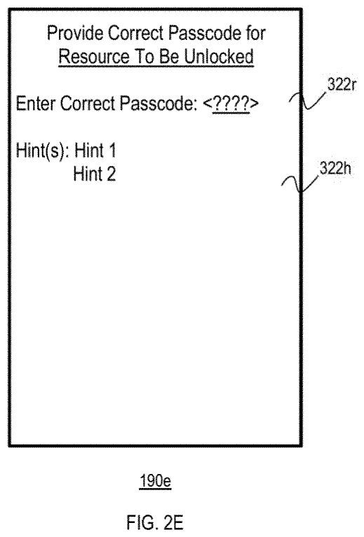

As shown in FIG. 2, one specific example of electronic device 100 may be a handheld electronic device, such as an iPhone™, where housing 101 may allow access to various input components 110a-110i, various output components 112a-112c, and various I/O components 111a-111d through which device 100 and a user and/or an ambient environment may interface with each other. Input component 110a may include a button that, when pressed, may cause a “home” screen or menu of a currently running application to be displayed by device 100. Input component 110b may be a top or side button for toggling electronic device 100 between a sleep mode and a wake mode or between any other suitable modes. Input component 110c may include a two-position slider that may disable one or more output components 112 in certain modes of electronic device 100. Input components 110d and 110e may include buttons for increasing and decreasing the volume output or any other characteristic output of an output component 112 of electronic device 100. Each one of input components 110a-110e may be a mechanical input component, such as a button supported by a dome switch, a sliding switch, a control pad, a key, a knob, a scroll wheel, or any other suitable form.

An output component 112a may be a display that can be used to display a visual or graphic user interface (“GUI”) 180, which may allow a user to interact with electronic device 100. GUI 180 may include various layers, windows, screens, templates, elements, menus, and/or other components of a currently running application (e.g., application 103) that may be displayed in all or some of the areas of display output component 112a. One or more of user input components 110a-110i may be used to navigate through GUI 180 (e.g., from GUI screen 190 of FIG. 2). For example, one user input component 110 may include a scroll wheel that may allow a user to select one or more graphical elements 182 of GUI 180. Icons 182 may also be selected via a touch screen I/O component 111a that may include display output component 112a and an associated touch input component 110f. Such a touch screen I/O component 111a may employ any suitable type of touch screen input technology, such as, but not limited to, resistive, capacitive, infrared, surface acoustic wave, electromagnetic, or near field imaging. Furthermore, touch screen I/O component 111a may employ single point or multi-point (e.g., multi-touch) input sensing.

Icons 182 may represent various layers, windows, screens, templates, elements, and/or other components that may be displayed in some or all of the areas of display component 112a upon selection by the user. Furthermore, selection of a specific icon 182 may lead to a hierarchical navigation process. For example, selection of a specific icon 182 may lead to a new screen of GUI 180 that may include one or more additional icons or other GUI elements of the same application or of a new application associated with that icon 182. Textual indicators 181 may be displayed on or near each icon 182 to facilitate user interpretation of each graphical element icon 182. It is to be appreciated that GUI 180 may include various components arranged in hierarchical and/or non-hierarchical structures. When a specific icon 182 is selected, device 100 may be configured to open a new application associated with that icon 182 and display a corresponding screen of GUI 180 associated with that application. For example, when the specific icon 182 labeled with a “Music” textual indicator 181 is selected, device 100 may launch or otherwise access a specific music application (e.g., application 103) and may display screens of a specific user interface that may include one or more tools or features for interacting with such a music application (see, e.g., FIGS. 2A-2E for specific examples of such displays of GUI 180 during use of any suitable application (e.g., a passcode recommendation and management application 103 that may be used by a device user for remembering and/or selecting a new passcode for use in accessing one or more protected resources (e.g., any other suitable applications))). For each application, screens may be displayed on display output component 112a and may include various user interface elements. Additionally or alternatively, for each application, various other types of non-visual information may be provided to a user via various other output components 112 of device 100.

Electronic device 100 also may include various other I/O components 111 that may allow for communication between device 100 and other devices. I/O component 111b may be a connection port that may be configured for transmitting and receiving data files, such as media files or customer order files, from a remote data source and/or power from an external power source. For example, I/O component 111b may be a proprietary port, such as a Lightning™ connector or a 30-pin dock connector from Apple Inc. of Cupertino, Calif. I/O component 111c may be a connection slot for receiving a SIM card or any other type of removable component. Electronic device 100 may also include at least one audio input component 110g, such as a microphone, and at least one audio output component 112b, such as an audio speaker.

Electronic device 100 may also include at least one tactile or haptic output component 112c (e.g., a rumbler or any other suitable subsystem operative to provide haptic or tactile feedback to a user), a camera and/or scanner input component 110h (e.g., a video or still camera, and/or a bar code scanner or any other suitable scanner that may obtain product identifying information from a code, such as a bar code, a QR code, or the like), and a biometric input component 110i (e.g., a fingerprint reader or other feature recognition sensor, which may operate in conjunction with a feature-processing application that may be accessible to electronic device 100 for authenticating a user). At least a portion of biometric input component 110i may be incorporated under or otherwise combined with input component 110a or any other suitable I/O component of device 100. For example, biometric input component 110i may be a fingerprint reader that may be configured to scan the fingerprint of a user's finger as the user interacts with mechanical input component 110a by pressing input component 110a with that finger. As another example, biometric input component 110i may be a fingerprint reader that may be combined with touch input component 110f of touch screen I/O component 111a, such that biometric input component 110i may be configured to scan the fingerprint of a user's finger as the user interacts with touch screen input component 110f by pressing or sliding along touch screen input component 110f with that finger. Another example of a biometric input component may be any component that facilitates facial recognition.

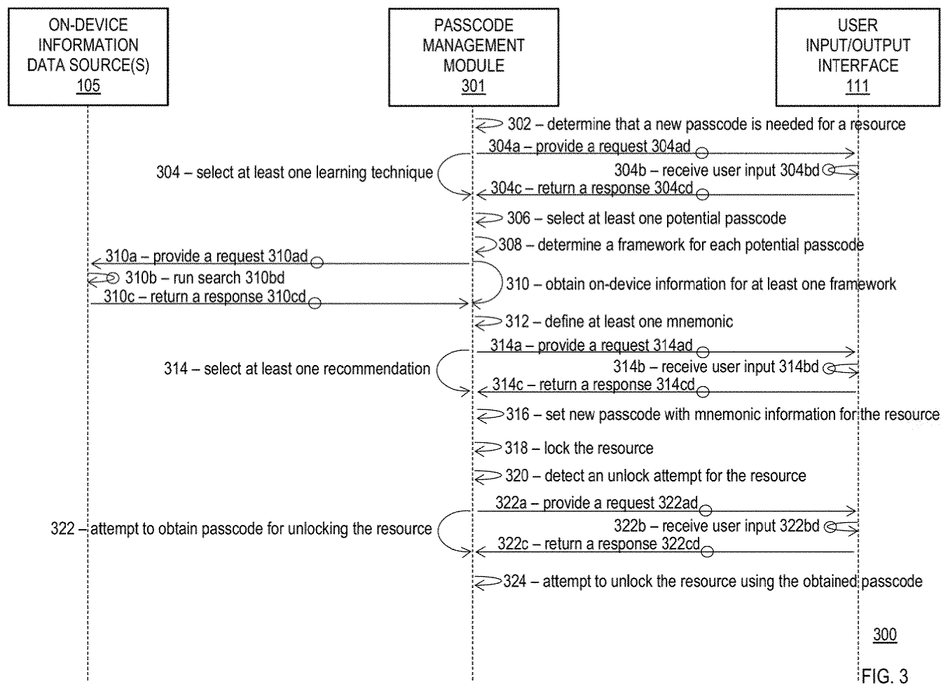

FIG. 3 is a flowchart of an illustrative process 300 for recommending passcodes for an electronic device using information local to the electronic device. Process 300 is shown being implemented by various components of electronic device 100, such as a passcode management module 301 (e.g., any suitable passcode management application 103 available on device 100 (e.g., any suitable operating system or software or firmware or hardware module that may be run by and/or executed on and/or otherwise provided by processor 102)), at least one on-device information data source 105 (e.g., any suitable data structure that may be available on device 100 (e.g., any suitable data from any on-device application that may be stored in memory 104 (e.g., user data in any suitable calendar application, media application (e.g., music app, movie app, photo app, etc.), contacts application, and/or the like))), and a user I/O interface 111 (e.g., I/O interface 111a or any other suitable input component and output component combination). However, it is to be understood that process 300 may be implemented using any other suitable components or subsystems or modules or data structures available on device 100. Process 300 may provide a seamless user experience for securely and efficiently defining a new passcode for a device resource to be protected through use of one or more recommendations that may be based on any suitable information local to the electronic device (e.g., local information that may be unique to the one or more users of device 100 (e.g., due to use of the device and definition of certain data structures of one or more applications on device 100)). To facilitate the following discussion regarding the operation of device 100 for recommending and managing passcodes according to process 300 of FIG. 3, reference is made to various components of device 100 of the schematic diagram of FIG. 1, and to front views of screens 190-190e of FIGS. 2-2E that may be representative of a graphical user interface of device 100 (e.g., a GUI as may be provided by passcode management application 103 or any other suitable application of device 100) during such a passcode recommendation and management process. The operations described may be achieved with a wide variety of graphical elements and visual schemes. Therefore, the embodiments of FIGS. 2-2E are not intended to be limited to the precise user interface conventions adopted herein. Rather, embodiments may include a wide variety of user interface styles. Alternatively, in some embodiments, one or more non-graphical user interface conventions may be used, including, but not limited to, conventions using audio output data presentation, audio input data reception, haptic output data presentation, non-visual input data reception (e.g., mechanical button presses or motion sensor input data reception, etc.), and/or the like.

Process 300 may begin at operation 302, where passcode management module (PMM) 301 may determine that a new passcode is to be set for protecting a resource. Operation 302 may occur in response to any suitable event taking place, including, but not limited to, the complete or near expiration of a clock previously set to limit the duration of a previously set passcode for the resource, the complete or near depletion of a counter previously set to limit the amount of times that a passcode may be utilized for the resource, any event that may be determined to be suspicious enough to warrant a passcode reset (e.g., too many incorrect passcode entries), a user request to set a new passcode for the resource, and an initialization of a resource to be protected (e.g., the first time the device's operating system is being used by a new user). Any suitable resource may be protected by the passcode being set by process 300, including, but not limited to, an entire operating system of device 100 (e.g., entry of a passcode may be required in order for a user to gain access to the use of device 100 in any way), a particular higher level application of device 100 (e.g., entry of a passcode to access a particular wallet application of device 100), a particular functionality of device 100 (e.g., entry of a passcode to access the ability to call a particular person after a particular time of day), and/or the like. The new passcode determined to be needed at operation 302 may be of any suitable type or composition, including, but not limited to, a type limited to at least a minimum number of characters, a type limited to at most a maximum number of characters, a type limited to a specific number of characters, a type requiring at least one character of a specific character category (e.g., at least one number, at least one uppercase letter, at least one punctuation, at least one mathematical symbol, etc.), and/or the like. While various examples described herein may be with respect to a passcode defined by exactly 4-numerical digits, it is to be understood that any suitable passcode (e.g., any suitable passcode or password or passkey or passphrase or access code or personal identification number (PIN) or phoneword or the like) of any suitable composition may be used throughout process 300 and/or other processes described herein (e.g., an 8-character code, a 3-word phrase code, a spoken code of a certain length of time, etc.).

Once it has been determined at operation 302 that a new passcode of a particular type is needed for a resource, process 300 may proceed to operation 304, where PMM 301 may select at least one learning technique (e.g., at least one mnemonic or encoding technique or mnemonic system or mnemonic device or the like) that may be used to determine how to generate at least one mnemonic or tool that may be provided to a user of device 100 for use in remembering a recommended passcode. Any suitable learning technique may be selected at operation 304, including, but not limited to, the mnemonic major system, the Katapayadi system, the Dominic system, a name mnemonic system (e.g., an acronym system), a mnemonic peg system, a method of loci, a mnemonic link system, a linkword system, a chunking system, and/or the like. The selection of a learning technique at operation 304 may be at least partially based on any composition requirements of the passcode to be generated (e.g., a first learning technique may be available for selection when a passcode with a first composition is needed, while a second learning technique different than the first learning technique may be available for selection when a passcode with a second composition different than the first composition is needed, or different resources to be protected may utilized different learning techniques, or a user may select a particular learning technique, and/or the like).

The selection of at least one learning technique at operation 304 may be carried out automatically by device 100 (e.g., by PMM 301) without any user input. Alternatively, the selection of at least one learning technique at operation 304 may be at least partially based on some input provided by a user. For example, as shown in FIG. 3, operation 304 may include a first sub-operation 304a, where PMM 301 may provide a request 304ad to a user of device 100 via an output component of user I/O interface 111, which may enable the user to provide any suitable user input 304bd via an input component of user I/O interface 111 at sub-operation 304b, which may be returned to PMM 301 as a response 304cd at sub-operation 304c for use by PMM 301 in selecting the learning technique indicated by response 304cd.

Any suitable number of iterations of sub-operations 304a-304c may be carried out during operation 304 until at least one particular learning technique has been selected and/or any suitable characteristics (e.g., learning technique mappings, learning technique rule systems, etc.) of the selected learning technique have been defined and/or any suitable on-device information data source(s) have been selected as available for use with at least one of the learning techniques being selected (e.g., media application information, calendar application information, contact application information, etc.). For example, request 304ad of sub-operation 304a may be operative to present, to the user, screen 190a of FIG. 2A that may include a list 304l of any suitable learning techniques from which the user may select, at sub-operation 304b, at least one of the listed learning techniques for use in remembering a 4-digit-numerical passcode. As shown, for example, list 304l may include a first selectable option 304oa indicative of a telephone keypad system (word) learning technique, a second selectable option 304ob indicative of a mnemonic major system (word) learning technique, a third selectable option 304oc indicative of a telephone keypad system (phrase) learning technique, a fourth selectable option 304od indicative of a mnemonic major system (phrase) learning technique, a fifth selectable option 304oe indicative of a Dominic system (phrase) learning technique, a sixth selectable option 304of indicative of a word length system (phrase) learning technique, and/or the like. In response to being presented screen 190a based on request 304ad of sub-operation 304a, a user may interact with device 100 (e.g., with any suitable input component 110) in any suitable manner to select at least one of options 304oa-304of at sub-operation 304b, which may send response 304cd of sub-operation 304c to PMM 301 such that PMM 301 may select the learning technique of the at least one selected option for use.

In another iteration of operation 304 (e.g., in another iteration of sub-operations 304a-304c), one or more suitable characteristics (e.g., learning technique mappings, learning technique rule systems, etc.) of at least one selected learning technique may be defined. For example, request 304ad of sub-operation 304a of such an iteration may be operative to present, to the user, screen 190b of FIG. 2B that may include one or more learning technique characteristics 304x for a selected learning technique that the user may adjust, at another iteration of sub-operation 304b, for personalizing the selected learning technique. As shown, for example, characteristics 304x may include an option 304og for a user to edit a standard mapping of numerals to sounds or letters of a selected mnemonic major system. In response to being presented screen 190b based on request 304ad of such a sub-operation 304a, a user may interact with device 100 (e.g., with any suitable input component 110) in any suitable manner to adjust any of characteristics 304x at sub-operation 304b, which may send response 304cd of sub-operation 304c to PMM 301 such that PMM 301 may use such adjustments with the selected learning technique.

In another iteration of operation 304 (e.g., in another iteration of sub-operations 304a-304c), one or more on-device information data source(s) available to device 100 may be selected as available for use in defining at least one mnemonic or tool that may be generated in accordance with the selected learning technique. For example, request 304ad of sub-operation 304a of such an iteration may be operative to present, to the user, screen 190c of FIG. 2C that may include a list 304t of any suitable on-device information data source(s) from which the user may select, at sub-operation 304b, at least one of the listed on-device information data source(s) to be made available for potential use in defining at least one mnemonic or tool that may be generated in accordance with the selected learning technique. As shown, for example, list 304t may include a first selectable option 304oh indicative of a contacts application on device 100, a second selectable option 304oi indicative of a media application on device 100, a third selectable option 304oj indicative of a calendar application on device 100, a fourth selectable option 304ok indicative of a health application on device 100, a fifth selectable option 304ol indicative of a wallet application on device 100, and/or the like. In response to being presented screen 190c based on request 304ad of sub-operation 304a, a user may interact with device 100 (e.g., with any suitable input component 110) in any suitable manner to select at least one of options 304oh-304oj at sub-operation 304b, which may send response 304cd of sub-operation 304c to PMM 301 such that PMM 301 may at least partially limit the available on-device information data source(s) to be used for a particular selected learning technique to the at least one option selected for use by the user (e.g., a user may be enabled to selectively determine which, if any, on-device information data source(s) may be used by process 300 for passcode and mnemonic recommendation, where any data used from such on-device information data source(s) may be limited to on-device use and none of such data may be utilized by process 300 off of device 100 in any manner). Any iteration(s) of operation 304 may be carried out automatically by device 100 without any user input (e.g., PMM 301 may be configured to select automatically at least one particular learning technique with one or more particular characteristics and at least one information data source for use in defining at least one mnemonic or tool to be generated in accordance with the selected learning technique(s). Alternatively, one, some, or each of such selections may be enabled by the system to be made by a device user.

At operation 306, PMM 301 may select (e.g., automatically) at least one new passcode for potential use. Continuing with the example of a 4-digit numerical passcode composition, operation 306 may select at least one passcode from any of the entire set of 10,000 possible 4-digit numerical passcode options ranging from “0000” to “9999”. Alternatively, operation 306 may first reduce the pool of possible 4-digit numerical passcode options from such an entire set to an admissible set that may be defined in any suitable manner. For example, one or more inadmissible sets of passcodes may be defined in any suitable manner for removal from the entire set for arriving at an admissible set, including, but not limited to, an inadmissible set including any passcode previously used (e.g., by the user and/or for the resource being protected and/or by device 100) at any time during the life of device 100 and/or during a particular time period, an inadmissible set including any passcode that includes only one number (e.g., “0000” and “1111” and “2222”, etc.), an inadmissible set including any passcode including only consecutive numbers (e.g., “0123” and “1234” and “2345”, etc.), an inadmissible set including any passcode that could also define a calendar date (e.g., a “MMYY” date, such as “0197” and “1299”), and/or any other passcodes that may be identified as a weak passcode for whatever reason. In some embodiments, one or more inadmissible sets may be defined at least partially based on at least one learning technique selected at operation 304. When an admissible set has been identified, then operation 306 may also include selecting at least one passcode from that identified admissible set in any suitable manner. For example, at least one passcode may be selected for potential use from the admissible set using any suitable random selection process (e.g., a selection process using uniformly random probability). In some embodiments, one or more passcodes may be selected for potential use from the admissible set at least partially based on at least one learning technique selected at operation 304. Only one passcode may be selected for potential use at operation 306, or, alternatively, two or more passcodes may be selected for potential use at operation 306.

At operation 308, PMM 301 may determine (e.g., automatically), for each learning technique (e.g., as selected at operation 304), a framework for generating a mnemonic based on that learning technique to be provided to a user of the electronic device for use in remembering a passcode (e.g., for one, some, or each passcode selected for potential use at operation 306). As an example, if a telephone keypad system (word) learning technique was selected at operation 304 (e.g., via user selection of option 304oa of FIG. 2A or automatically), and if passcode “4395” was selected as a potential passcode at operation 306, then PMM 301 may be configured to determine, at operation 308, a framework for generating a mnemonic that may require a 4-letter-word with not only a first letter being equal to one of “G” or “H” or “I” (i.e., the letters associated with the passcode's first number “4” on a standard mapping of telephone keypad system), but also a second letter being equal to one of “D” or “E” or “F” (i.e., the letters associated with the passcode's second number “3” on a standard mapping of telephone keypad system), and also a third letter being equal to one of “W” or “X” or “Y” or “Z” (i.e., the letters associated with the passcode's third number “9” on a standard mapping of telephone keypad system), and also a final letter being equal to one of “J” or “K” or “L” (i.e., the letters associated with the passcode's final number “5” on a standard mapping of telephone keypad system), for which, as just one example, the English word “IDYL” may satisfy such a framework.

As another example, if a mnemonic major system (word) learning technique was selected at operation 304 (e.g., via user selection of option 304ob of FIG. 2A or automatically), and if passcode “4395” was selected as a potential passcode at operation 306, then PMM 301 may be configured to determine, at operation 308, a framework for generating a mnemonic that may require a 4-letter-word with not only a first major consonant sound being equal to “R” (i.e., the sound(s) associated with the passcode's first number “4” on a standard mapping of a mnemonic major system), but also a second major consonant sound being equal to “M” (i.e., the sound(s) associated with the passcode's second number “3” on a standard mapping of a mnemonic major system), and also a third major consonant sound being equal to “P” or “B” (i.e., the sound(s) associated with the passcode's third number “9” on a standard mapping of a mnemonic major system), and also a final major consonant sound being equal to “L” (i.e., the sound(s) associated with the passcode's final number “5” on a standard mapping of a mnemonic major system), for which, as just one example, the English word “RAMBLE” may satisfy such a framework.

As yet another example, if a telephone keypad system (phrase) learning technique was selected at operation 304 (e.g., via user selection of option 304oc of FIG. 2A or automatically), and if passcode “4395” was selected as a potential passcode at operation 306, then PMM 301 may be configured to determine, at operation 308, a framework for generating a mnemonic that may require a 4-word-phrase with not only a first word starting with a letter being equal to one of “G” or “H” or “I” (i.e., the letters associated with the passcode's first number “4” on a standard mapping of telephone keypad system), but also a second word starting with a letter being equal to one of “D” or “E” or “F” (i.e., the letters associated with the passcode's second number “3” on a standard mapping of telephone keypad system), and also a third word starting with a letter being equal to one of “W” or “X” or “Y” or “Z” (i.e., the letters associated with the passcode's third number “9” on a standard mapping of telephone keypad system), and also a final word starting with a letter being equal to one of “J” or “K” or “L” (i.e., the letters associated with the passcode's final number “5” on a standard mapping of telephone keypad system), for which, as just one example, the English phrase “Iguanas Drink Yellow Liquid” may satisfy such a framework.

As yet another example, if a mnemonic major system (phrase) learning technique was selected at operation 304 (e.g., via user selection of option 304od of FIG. 2A or automatically), and if passcode “4395” was selected as a potential passcode at operation 306, then PMM 301 may be configured to determine, at operation 308, a framework for generating a mnemonic that may require a 4-word-phrase with not only a first word starting with a major consonant sound being equal to “R” (i.e., the sound(s) associated with the passcode's first number “4” on a standard mapping of a mnemonic major system), but also a second word starting with a major consonant sound being equal to “M” (i.e., the sound(s) associated with the passcode's second number “3” on a standard mapping of a mnemonic major system), and also a third word starting with a major consonant sound being equal to “P” or “B” (i.e., the sound(s) associated with the passcode's third number “9” on a standard mapping of a mnemonic major system), and also a final word starting with a major consonant sound being equal to “L” (i.e., the sound(s) associated with the passcode's final number “5” on a standard mapping of a mnemonic major system), for which, as just one example, the English phrase “Rake My Back Lawn” may satisfy such a framework.

As yet another example, if a Dominic system (phrase) learning technique was selected at operation 304 (e.g., via user selection of option 304oe of FIG. 2A or automatically), and if passcode “4395” was selected as a potential passcode at operation 306, then PMM 301 may be configured to determine, at operation 308, a framework for generating a mnemonic that may require a 4-word-phrase with not only the first two words of the phrase being equal to the name of a person with the initials “D.C.” (i.e., the initials of a person with not only a first name starting with the letter “D” (i.e., the letter associated with the passcode's first number “4” on a standard mapping of a Dominic system) but also a last name starting with the letter “C” (i.e., the letter associated with the passcode's second number “3” on a standard mapping of a Dominic system)), but also the last two words of the phrase being equal to an activity associated with a person with the initials “N.E.” (i.e., an activity associated with a person with not only a first name starting with the letter “N” (i.e., the letter associated with the passcode's third number “9” on a standard mapping of a Dominic system) but also a last name starting with the letter “E” (i.e., the letter associated with the passcode's last number “5” on a standard mapping of a Dominic system)), for which, as just one example, the English phrase “Daniel Craig Writing Books” may satisfy such a framework (e.g., where the initials of the person “Daniel Craig” are “D.C.” and where a person Nora Ephron with the initials “N.E.” is associated with the activity of “Writing Books”).

As yet another example, if a word length system (phrase) learning technique was selected at operation 304 (e.g., via user selection of option 304of of FIG. 2A or automatically), and if passcode “4395” was selected as a potential passcode at operation 306, then PMM 301 may be configured to determine, at operation 308, a framework for generating a mnemonic that may require a 4-word-phrase with not only a first word having exactly four letters (i.e., the number of letters equal to the passcode's first number “4”), but also a second word having exactly three letters (i.e., the number of letters equal to the passcode's second number “3”), and also a third word having exactly nine letters (i.e., the number of letters equal to the passcode's third number “9”), and also a final word having exactly five letters (i.e., the number of letters equal to the passcode's final number “5”), for which, as just one example, the English phrase “next day amplifier store” may satisfy such a framework.

Once a framework has been determined at operation 308 (e.g., for at least one potential passcode selected at operation 306) using at least one learning technique selected at operation 304, then process 300 may proceed to operation 310, where PMM 301 may obtain (e.g., automatically) any suitable on-device information from one or more appropriate on-device information data sources (e.g., as selected at operation 304 (e.g., automatically or via user selection)) that may potentially be used to satisfy such a framework. For a particular on-device information data source, operation 310 may be operative to obtain any suitable information from that data source, such as a word or group of words, that may satisfy one or more of the limitations of a determined framework (e.g., information from a contacts application data source that may include one or more contacts, each of which may include the contact's name and one or more telephone numbers and/or one or more e-mail addresses and/or one or more physical mailing addresses and/or one or more occupations and/or a birthday and/or a relative's name and/or any suitable image(s) thereof, and/or the like, information from a media application data source that may include one or more song names and associated metadata (e.g., name of song's artist, date of song's release, hometown of song's artist, description of topic of song, genre of song, any suitable image(s) thereof, and/or the like) and/or one or more movie names and associated metadata (e.g., name of movie's director and/or actors, date of movie's release, filming location of movie, description of topic of movie, genre of movie, any suitable image(s) thereof, and/or the like) and/or one or more photograph names and associated metadata (e.g., location where photograph was taken, name of subject(s) of photograph, and/or the like) and/or the like, information from a calendar application data source that may include one or more events, each of which may include the event's time, the event's location, the event's participants, the event's type, information from a health application, information from a wallet application, and/or the like, etc.). For example, if a telephone keypad system (word) learning technique was selected at operation 304, and if passcode “4395” was selected as a potential passcode at operation 306, and if a framework was determined at operation 308 that may be satisfied as described above (e.g., by the English word “IDYL”), then operation 310 may include obtaining any suitable word(s) and/or any suitable phrase(s) and/or any other suitable information from any suitable data source(s) that may also satisfy that framework. As another example, if a mnemonic major system (word) learning technique was selected at operation 304, and if passcode “4395” was selected as a potential passcode at operation 306, and if a framework was determined at operation 308 that may be satisfied as described above (e.g., by the English word “RAMBLE”), then operation 310 may include obtaining any suitable word(s) and/or any suitable phrase(s) and/or any other suitable information from any suitable data source(s) that may also satisfy that framework. As yet another example, if a telephone keypad system (phrase) learning technique was selected at operation 304, and if passcode “4395” was selected as a potential passcode at operation 306, and if a framework was determined at operation 308 that may be satisfied as described above (e.g., by the English phrase “Iguanas Drink Yellow Liquid”), then operation 310 may include obtaining any suitable word(s) and/or any suitable phrase(s) and/or any other suitable information from any suitable data source(s) that may also satisfy that framework. As yet another example, if a mnemonic major system (phrase) learning technique was selected at operation 304 (e.g., via option 304od of FIG. 2A), and if passcode “4395” was selected as a potential passcode at operation 306, and if a framework was determined at operation 308 that may be satisfied as described above (e.g., by the English phrase “Rake My Back Lawn”), then operation 310 may include obtaining any suitable word(s) and/or any suitable phrase(s) and/or any other suitable information from any suitable data source(s) that may also satisfy that framework. As yet another example, if a Dominic system (phrase) learning technique was selected at operation 304, and if passcode “4395” was selected as a potential passcode at operation 306, and if a framework was determined at operation 308 that may be satisfied as described above (e.g., by the English phrase “Daniel Craig Writing Books”), then operation 310 may include obtaining any suitable word(s) and/or any suitable phrase(s) and/or any other suitable information from any suitable data source(s) that may also satisfy that framework. As yet another example, if a word length system (phrase) learning technique was selected at operation 304, and if passcode “4395” was selected as a potential passcode at operation 306, and if a framework was determined at operation 308 that may be satisfied as described above (e.g., by the English phrase “next day amplifier store”), then operation 310 may include obtaining any suitable word(s) and/or any suitable phrase(s) and/or any other suitable information from any suitable data source(s) that may also satisfy that framework.

Only data associated with certain assets of the appropriate data source(s) (e.g., contacts of a contact app, songs and/or movies of a media app, events of a calendar app, etc.) that meet a certain criteria (e.g., that have been most recently accessed and/or that have been most frequently accessed) may be searched through and from which the framework satisfying information may be obtained at operation 310. Alternatively, all data available to an appropriate data source that may satisfy a framework may be obtained at operation 310. The obtaining of framework satisfying information from an on-device data source may be carried out in any suitable manner, including, but not limited to, using any suitable application programming interfaces (APIs) or the like (e.g., automatically, and/or wherein operation 310 may include a first sub-operation 310a, where PMM 301 may provide a request 310ad to an on-device information source 105, which may enable the information source to run its own search 310bd based on request 310ad at sub-operation 310b, the results of which may be returned to PMM 301 as a response 310cd at sub-operation 310c for use by PMM 301 (e.g., at operation 312). In some embodiments, at least the most frequently accessed media assets (e.g., data elements as most frequently accessed by the user during any suitable time period prior to operation 310) may be accessed at operation 310 (e.g., data elements indicative of the most listened to song or of the ten most listened to songs by the user over the last two weeks). Additionally or alternatively, inferred concepts may be used to at least partially define one or more data elements accessed at operation 310 (e.g., “cats” may be an inferred topic of a most recently defined or accessed photo stream from a photo album application of the device). Also things that either co-occur (e.g., names of people who “like” photos in a particular photo stream) and/or data from inferred concepts (e.g., “cats” may be an inferred topic in a photo stream, where the process (e.g., during operation 310) may be configured to present one or more images from the photo stream to request and collect data from the user indicative of the name(s) and/or home location of one or more cats from the photographs, where such collected name(s) and/or locations may then be used after operation 310 similar to other information that may be collected during operation 310, as such name and/or location data may be difficult to guess or look up or be phished) at a later time. Any suitable number of iterations of sub-operations 310a-310c may be carried out during operation 310 for any suitable number of data sources 105 and/or for any suitable number of frameworks.

Any appropriate on-device information obtained from any appropriate on-device data sources may then be used to generate one or more mnemonics for use in remembering a recommended passcode. For example, for a particular framework determined at operation 308 for a particular passcode selected at operation 306 for a particular learning technique selected at operation 304 using information obtained at operation 310, process 300 may attempt to define (e.g., automatically by PMM 301) at least one mnemonic at operation 312 for that passcode, technique, and framework with appropriate obtained information. Any suitable processing may be carried out at operation 312 to make such mnemonic defining efficient and effective (e.g., such that the obtained information used to define the mnemonic may be as relevant as possible to the device user and/or such that the defined mnemonic may be as coherent as possible to device user). For example, if a telephone keypad system (word) learning technique was selected at operation 304, and if passcode “4395” was selected as a potential passcode at operation 306, and if a framework was determined at operation 308 that may be satisfied as described above (e.g., by the English word “IDYL”), then operation 312 may be operative to define a mnemonic satisfying that framework using the word “HEXL” if information obtained from a media application at operation 310 may be indicative of an artist “D.J. Hexl” being a popular artist most frequently listened to by the user of device 100. As another example, if a mnemonic major system (word) learning technique was selected at operation 304, and if passcode “4395” was selected as a potential passcode at operation 306, and if a framework was determined at operation 308 that may be satisfied as described above (e.g., by the English word “RAMBLE”), then operation 312 may be operative to define a mnemonic satisfying that framework using the word “REMPEL” if information obtained from a media application at operation 310 may be indicative of an artist “Mike Rempel” being a popular artist most frequently listened to by the user of device 100, and/or operation 312 may be operative to define a mnemonic satisfying that framework using the word “RAMBLE” if information obtained from a media application at operation 310 may be indicative of a song “Ramble On Rose” being a popular song frequently listened to by the user of device 100. As yet another example, if a telephone keypad system (phrase) learning technique was selected at operation 304, and if passcode “4395” was selected as a potential passcode at operation 306, and if a framework was determined at operation 308 that may be satisfied as described above (e.g., by the English phrase “Iguanas Drink Yellow Liquid”), then operation 312 may be operative to define a mnemonic satisfying that framework using the phrase “Irina Davis, Youngsville, La.” if information obtained from a contact application at operation 310 may be indicative of a contact named “Irina Davis” that has a mailing address in “Youngsville, La.”. As yet another example, if a mnemonic major system (phrase) learning technique was selected at operation 304, and if passcode “4395” was selected as a potential passcode at operation 306, and if a framework was determined at operation 308 that may be satisfied as described above (e.g., by the English phrase “Rake My Back Lawn”), then operation 312 may be operative to define a mnemonic satisfying that framework using the phrase “Rock, May, Brian Lawson” if information obtained from a calendar application at operation 310 may be indicative of a previous or upcoming event for “rock” climbing in the month of “May” with an event participant named “Brian Lawson”. As yet another example, if a Dominic system (phrase) learning technique was selected at operation 304, and if passcode “4395” was selected as a potential passcode at operation 306, and if a framework was determined at operation 308 that may be satisfied as described above (e.g., by the English phrase “Daniel Craig Writing Books”), then operation 312 may be operative to define a mnemonic satisfying that framework using the phrase “Derek Caruso Making Cakes” if information obtained from a contact application at operation 310 may be indicative of a first popular contact named “Derek Caruso” and a second popular contact named “Nick Esposito” that has a listed occupation as a “Cake Maker”. As yet another example, if a word length system (phrase) learning technique was selected at operation 304, and if passcode “4395” was selected as a potential passcode at operation 306, and if a framework was determined at operation 308 that may be satisfied as described above (e.g., by the English phrase “next day amplifier store”), then operation 312 may be operative to define a first mnemonic satisfying that framework using the phrase “Rose Way, Screaming Trees” if information obtained from a media application at operation 310 may be indicative of a song called “Rose Way” being the user's most played song by a grunge artist based in Seattle called “The Screaming Trees” and a second mnemonic satisfying that framework using the phrase “John Doe, Swordfish Meal” if information obtained from a media application at operation 310 may be indicative of a group of recently taken pictures being tagged with a subject “John Doe” and “swordfish” and “dinner.” Obtained data may be made into a mnemonic by mapping terms into a phrase according to any suitable characteristics, including, but not limited to, initial letters, number of letters, major consonants, any suitable element associations (e.g., name initials to occupation), and/or the like. Various types of processing may be automatically carried out to use the obtained data efficiently and effectively for defining a mnemonic using the appropriate framework. For example, part of speech tagging for one or more words or phrases or terms or the like from the obtained data can be used to place them into syntactically accurate positions without worrying about semantics, which may enable the generation of more memorable phrases because the absence of semantic coherence can be jarring when the syntax makes sense.

Once one or more mnemonics have been defined at operation 312 for at least one framework with respect to a particular selected technique and passcode using information from at least one appropriate data source, process 300 may proceed to operation 314, where PMM 301 may select (e.g., automatically) at least one defined mnemonic to be provided as or included as or represented in any suitable manner by a portion of a recommendation to a user of device 100 for use in remembering a recommended passcode associated with that mnemonic. Any suitable processing may be carried out at operation 314 to make such a selection of at least one mnemonic from the mnemonic(s) defined at operation 312 for use as a recommendation to the user (e.g., such that the selected mnemonic may be as relevant as possible to the device user (e.g., terms from the obtained data or mnemonics containing terms from the obtained data may be selected based on a user's frequency of interaction with those terms (e.g., how often the user calls the contact from which a term came, how often the user listens to a song from which the term came, etc. (e.g., entropy of terms from the obtain data may be used))) and/or such that the selected mnemonic may be as coherent as possible to device user). In some embodiments, the same or even similar mnemonics may not be utilized for two different recommendations (e.g., at two different iterations of process 300) in order to maintain stronger security. The selection of at least one mnemonic at operation 314 may be carried out automatically by device 100 (e.g., by PMM 301) without any user input. Alternatively, the selection of at least one mnemonic at operation 314 may be at least partially based on some input provided by a user. For example, as shown in FIG. 3, operation 314 may include a first sub-operation 314a, where PMM 301 may provide a request 314ad to a user of device 100 via an output component of user I/O interface 111, which may enable the user to provide any suitable user input 314bd via an input component of user I/O interface 111 at sub-operation 314b, which may be returned to PMM 301 as a response 314cd at sub-operation 314c for use by PMM 301 in selecting the mnemonic and associated passcode indicated by response 314cd. Any suitable number of iterations of sub-operations 314a-314c may be carried out during operation 314 until a particular recommendation (e.g., mnemonic and/or associated passcode and/or technique) has been selected. For example, request 314ad of sub-operation 314a may be operative to present, to the user, screen 190d of FIG. 2D that may include a list 314l of any mnemonics defined at operation 312 along with their respective associated passcodes and techniques from which the user may select, at sub-operation 314b, a particular mnemonic and associated passcode. As shown, for example, list 314l may include a first selectable option 314oa including a representation (e.g., textual listing) indicative of a mnemonic “HEXL” and a telephone keypad system (word) learning technique for a passcode “4395”, a second selectable option 314ob including a representation (e.g., textual listing) indicative of a mnemonic “REMPEL” and a mnemonic major system (word) learning technique for a passcode “4395”, a third selectable option 314oc including a representation (e.g., textual listing) indicative of a mnemonic “Irina Davis, Youngsville, La.” and a telephone keypad system (phrase) learning technique for a passcode “4395”, a fourth selectable option 314od including a representation (e.g., textual listing) indicative of a mnemonic “Rock, May, Brian Lawson” and mnemonic major system (phrase) learning technique for a passcode “4395”, a fifth selectable option 314oe including a representation (e.g., textual listing) indicative of a mnemonic “Derek Caruso Making Cakes” and a Dominic system (phrase) learning technique for a passcode “4395”, a sixth selectable option 314of including a representation (e.g., textual listing) indicative of a mnemonic “Rose Way, Screaming Trees” and a word length system (phrase) learning technique for a passcode “4395”, a seventh selectable option 314og including a representation (e.g., textual listing) indicative of a mnemonic “John Doe, Swordfish Meal” and a word length system (phrase) learning technique for a passcode “4395”, and/or the like. In response to being presented screen 190d based on request 314ad of sub-operation 314a, a user may interact with device 100 (e.g., with any suitable input component 110) in any suitable manner to select at least one of options 314oa-314og at sub-operation 314b, which may send response 314cd of sub-operation 314c to PMM 301 such that PMM 301 may select the particular mnemonic and technique and passcode of the at least one selected option for use. It is to be understood that any suitable number of mnemonic options for the same passcode or for different passcodes (for the same or different techniques) may be presented by list 314l and a user of device 100 may select any option using any suitable decision making process (e.g., which ever option the user thinks it will be most likely to remember).

Once a recommendation (e.g., mnemonic and/or associated passcode and/or technique) has been selected at operation 314, process 300 may include operation 316, where the passcode of that selected recommendation may be set as the new passcode by PMM 301 (e.g., the new passcode identified as needed for a resource at operation 302) and that new passcode may be associated with its associated mnemonic and associated technique by PMM 301 (e.g., the passcode, associated mnemonic, associated technique, and/or any suitable hints may be stored in any suitable (e.g., obfuscated) secure manner (e.g., in any suitable data structure(s) accessible by PMM 301 (e.g., memory 104)) that may protect the security of that information and the device resource(s) that the information protects). Additionally, any suitable clock and/or counter and/or the like may be associated with the new passcode by PMM 301 for use in determining when that new passcode must itself be replaced (e.g., at a new iteration of operation 302). Any defined mnemonic(s), any obtained data, any new passcode, any new clock, and/or any new counter generated or otherwise acquired or obtained or defined by process 300 may be retained or stored or otherwise utilized by process 300 solely on device 100 and no such information may be stored or utilized on any other device or server or otherwise remote from device 100. Alternatively, if any such data is used by process 300 or otherwise off of device 100, such data may be obfuscated or encoded in one or more ways such that the data may not be properly utilized or identified by an inappropriate entity. Then, at operation 318 of process 300, the resource to be protected by the new passcode set at operation 316 may be locked by PMM 301. Then, at operation 320 of process 300 (e.g., at any suitable time after operation 318), an attempt to unlock the resource locked at operation 318 may be detected by PMM 301 (e.g., through any suitable device event (e.g., detection of any suitable user input(s) or otherwise)). Then, at operation 322 of process 300, PMM 301 may attempt to obtain the appropriate passcode currently set for the resource for which an unlock attempt was detected at operation 320. For example, as shown in FIG. 3, operation 322 may include a first sub-operation 322a, where PMM 301 may provide a request 322ad to a user of device 100 via an output component of user I/O interface 111, which may prompt and/or enable the user to provide any suitable user input 322bd via an input component of user I/O interface 111 at sub-operation 322b, which may be returned to PMM 301 as a response 322cd at sub-operation 322c for use by PMM 301 in determining whether or not to unlock the appropriate resource at operation 324 using a passcode indicated by response 322cd. Any suitable number of iterations of sub-operations 322a-322c may be carried out during operation 322 until the correct appropriate passcode has been received and/or the unlock attempt is cancelled and/or too many incorrect passcodes have been received. For example, request 322ad of sub-operation 322a may be operative to present, to the user, screen 190e of FIG. 2E that may include a request 322r for the user to provide the correct passcode (e.g., the passcode selected at operation 314 and set at operation 316). In some embodiments, as shown, one or more hints 322h may be automatically provided along with request 322r (or in response to a request for such a hint from the user), where hint 322h may include any suitable information, including, but not limited to, information indicative of the length of the correct pass code (e.g., 4-digits), information indicative of the composition of the correct pass code (e.g., 4-numerical-digits), information indicative of the learning technique associated with the correct passcode (e.g., “word length system (phrase)” if either option 314of or option 314og was selected at operation 314), information indicative of any characteristics of the learning technique associated with the correct passcode (e.g., provide the mapping associated with the mnemonic major system if either option 314ob or option 314od was selected at operation 314), information indicative of any characteristics of the on-device data source(s) used to generate the mnemonic (e.g., provide identification of a photograph media application if option 314og was selected at operation 314), information indicative of some clue that the user may be able to use to remember the mnemonic associated with the correct passcode but not the mnemonic itself (e.g., your most played song by a grunge band from Seattle (e.g., if option 314of was selected at operation 314)), and/or information indicative of the actual mnemonic associated with the correct passcode (e.g., “Rose Way, Screaming Trees” if option 314of was selected at operation 314), although it is to be appreciated that the correct passcode might not be secure if the mnemonic and associated technique for the correct passcode were both provided as portions of hint 322h, as such a hint may be able to be used by an imposter to reconstruct the correct passcode. If a user cannot remember the passcode but can remember one or more words of the mnemonic, the user may be enabled to enter the one or more recalled mnemonic words (e.g., rather than entering the passcode (e.g., a user may enter “Rose Trees” rather than “4395”)), and, if one or more correct mnemonic words are provided, then PMM 301 may be configured to return one or more hints to help the user recall the correct passcode (e.g., PMM 301 may return the full mnemonic of “Rose Way, Screaming Trees”). If a user correctly enters a passcode with or without any hints, PMM 301 may be configured to provide the user with one, some, or each available hint and/or the full mnemonic and/or associated learning technique and/or the like in order to reinforce the memory device being used to help aid in the recollection of the correct passcode. Any suitable rate limit controls may be employed to a recovery hinting process (e.g., an exponential backoff may be used). However, a goal of process 300 may be to improve user outcomes and mnemonics and certain hint sharing may enable this in a secure and effective manner.

It is understood that the operations shown in process 300 of FIG. 3 are only illustrative and that existing operations may be modified or omitted, additional operations may be added, and the order of certain operations may be altered. For example, in some embodiments, operation 306 may occur before operation 304, such that at least one potential passcode may be selected before one or more learning techniques and/or available data sources have been selected. As another example, each one of operations 304, 308, and 310 may be carried out prior to operation 306, such that a learning technique and data source(s) may be selected and on-device information may be obtained and at least some suitable (if not less specific) framework may be determined prior to one or more potential passcodes being selected. In such instances, a potential passcode might be selected at operation 306 more efficiently or effectively (e.g., in coordination with a more efficient and/or more effective operation 312) such that one or more mnemonics may be defined in coordination with potential passcode selection in light of on-device information that may be obtained in light of a learning technique and some framework, but without being restricted to a framework for a particular potential passcode or set of specific potential passcodes. In some embodiments, a user himself or herself may be enabled to select a potential passcode (e.g., at operation 304 and/or 306 and/or a combination thereof), or when a potential passcode may be selected in any other manner prior to obtaining data and/or defining at least one mnemonic, then process 300 may be operative to more efficiently obtain data and/or select a learning technique and/or define a mnemonic within the constraints of the selected potential passcode. In some embodiments, one or more potential mnemonics may be defined (e.g., using any suitable obtained on-device data and/or any suitable learning technique(s)), and then one or more potential passcodes that align with such a mnemonic (and any associated learning technique) may be selected (e.g., operation 306 may occur after operation 312) (e.g., in response to determining (e.g., at operation 310) that the song “Rose Way” by the band “Screaming Trees” is a most played song, PMM 301 may then be operative to automatically select a word length system (phrase) learning technique (e.g., at operation 304) and automatically determine (e.g., at operation 312) that “Rose Way, Screaming Trees” defines a mnemonic satisfying a framework for that learning technique if a passcode “4395” is selected (e.g., at operation 306)). Data obtainment and analysis for determining a mnemonic prior to passcode selection may enable more flexibility to use a more memorable mnemonic than might be possible if the passcode were selected prior to mnemonic determination. As mentioned, multiple techniques and/or multiple data sources may be selected at operation 304 and/or multiple potential passcodes may be selected at operation 306, such that multiple frameworks may be determined at operation 308 and/or such that multiple frameworks may be used at operation 312 for generating multiple mnemonics, and/or such that a recommendation request to a user (e.g., at sub-operation 314b) may be indicative of recommendations for two or more different potential passcodes.

Therefore, various different processes may be carried out (e.g., automatically by PMM 301 and/or with any suitable input from a device user) for recommending passcodes for an electronic device using information local to the electronic device. Such processes may be carried out entirely on device 100, not only for protecting the privacy of the user's on-device information but also for protecting the passcodes and any associated hint information (e.g., mnemonics, learning techniques, etc.). Memorization of strong (e.g., non-user generated) passcodes may be triggered based on any suitable learning techniques and local information that may be uniquely identifiable or otherwise meaningful to a user to aid in the memorization process. Any suitable learning technique(s) may be used in combination with any suitable on-device information or otherwise (e.g., device generated terms that may supplement any on-device information) in order to encode a passcode for enabling the passcode to be efficiently and effectively memorized by a user. In some embodiments, a mnemonic may be supplemented with or provided entirely as an image or movie or any other suitable media or output information type for facilitating such memorization. For example, when a mnemonic may be defined as or might otherwise be defined as “John Doe, Swordfish Meal,” a mnemonic and/or a hint provided to the user (e.g., at option 314og) may be or at least may include an actual photograph of John Doe and/or a Swordfish (e.g., a photograph from the data source from which the on-device information used to define the mnemonic may have been obtained (e.g., photo album of a photo app) and/or from any suitable supplementary data source (e.g., an image repository on a server remote from device 100 that may be accessible via communications component 106)).

As mentioned, while various examples described herein may be with respect to a passcode defined by exactly 4-numerical digits, it is to be understood that any suitable passcode (e.g., any suitable passcode or password or passkey or passphrase or access code or personal identification number (PIN) or phoneword or the like) of any suitable composition may be used throughout process 300 and/or other processes described herein. For example, if the passcode must include only 4-uppercase letters, and a potential passcode is selected at operation 306 as “IDYL” and a telephone keypad system (phrase) technique is selected, then process 300 may be carried out similarly as described herein for recommending the mnemonic of “Irina Davis, Youngsville, La.”. Alternatively or additionally, graphic (e.g., one or more images and/or videos) may be used to define a representation of a mnemonic for a particular passcode (e.g., for a passcode with a mnemonic “HWBS,” a representation of the mnemonic may be defined as a picture of a “H”orse “W”earing a “B”lue “S” weater), where such a topic for such a picture may be identified at least partially from the obtained data and/or where the picture itself may be obtained at least partially from the obtained data and/or from any other suitable data source. As another example, album artwork of music media and/or movie artwork or stills or .gifs or otherwise from video media and/or contact photographs from a contact of a contact app or the like may be used to define a mnemonic or a representation thereof in any suitable manner (e.g., an image of the album artwork for “Dark Side Of The Moon”, which may be determined to be a favorite album of the user, might be used to define a representation of a mnemonic for a passcode “3275” which may align with mnemonic letters “DARK” using a telephone keypad system (word) learning technique, where such an image may be obtained from an on-device information source (e.g., at operation 310) or may be obtained by PMM 301 (e.g., automatically) from any other suitable source (e.g., an image repository on a server remote from device 100 that may be accessible via communications component 106)) and provided as a representation of the mnemonic in a portion of the recommendation (e.g., the image of the album art work may be a representation of the mnemonic provided as a portion of the recommendation of an option in list 314l). In some embodiments, a user may be queried to enter the mnemonic itself (e.g., at request 322r) rather than the underlying passcode from which the mnemonic may have been derived, or the mnemonic may then be considered the passcode itself. As an example, if Noam Chomsky may be determined at operation 310 to be a favorite author of the user, then a passcode and/or mnemonic may be determined to be “Colorless Green Ideas Sleep Furiously” (e.g., a popular phrase associated with that author) and then one or more images may be used to provide a hint or to otherwise remind the user about how to memorize and/or recall that phrase, such as a first picture of a dog biting a biscuit (e.g., a “chomp” of the biscuit) and a second picture of a skier on a mountain slope (e.g., a “ski” activity), such that the two images when presented to a user may enable the user to come up with the terms “chomp” and “ski,” which may enable the user to recall the popular Chomsky phrase “Colorless Green Ideas Sleep Furiously” that may be entered by the user in any suitable manner to satisfy user access to the protected device resource.

Moreover, one, some, or all of the processes described with respect to FIGS. 1-3 may each be implemented by software, but may also be implemented in hardware, firmware, or any combination of software, hardware, and firmware. Instructions for performing these processes may also be embodied as machine- or computer-readable code recorded on a machine- or computer-readable medium. In some embodiments, the computer-readable medium may be a non-transitory computer-readable medium. Examples of such a non-transitory computer-readable medium include but are not limited to a read-only memory, a random-access memory, a flash memory, a CD-ROM, a DVD, a magnetic tape, a removable memory card, and a data storage device (e.g., an optical data storage device, such as memory 104 of FIG. 1). In other embodiments, the computer-readable medium may be a transitory computer-readable medium. In such embodiments, the transitory computer-readable medium can be distributed over network-coupled computer systems so that the computer-readable code is stored and executed in a distributed fashion. For example, such a transitory computer-readable medium may be communicated from one electronic device to another electronic device using any suitable communications protocol (e.g., the computer-readable medium may be communicated to electronic device 100 via communications component 106 (e.g., as at least a portion of application 103)). Such a transitory computer-readable medium may embody computer-readable code, instructions, data structures, program modules, or other data in a modulated data signal, such as a carrier wave or other transport mechanism, and may include any information delivery media. A modulated data signal may be a signal that has one or more of its characteristics set or changed in such a mariner as to encode information in the signal.

It is to be understood that any or each module (e.g., PMM 301) may be provided as a software construct, firmware construct, one or more hardware components, or a combination thereof. For example, any or each module may be described in the general context of computer-executable instructions, such as program modules, that may be executed by one or more computers or other devices. Generally, a program module may include one or more routines, programs, objects, components, and/or data structures that may perform one or more particular tasks or that may implement one or more particular abstract data types. It is also to be understood that the number, configuration, functionality, and interconnection of the modules are only illustrative, and that the number, configuration, functionality, and interconnection of existing modules may be modified or omitted, additional modules may be added, and the interconnection of certain modules may be altered.

At least a portion of one or more of the modules may be stored in or otherwise accessible to device 100 in any suitable manner (e.g., in memory 104 of device 100 (e.g., as at least a portion of application 103)). Any or each module may be implemented using any suitable technologies (e.g., as one or more integrated circuit devices), and different modules may or may not be identical in structure, capabilities, and operation. Any or all of the modules or other components may be mounted on an expansion card, mounted directly on a system motherboard, or integrated into a system chipset component (e.g., into a “north bridge” chip).

Any or each module may be a dedicated system implemented using one or more expansion cards adapted for various bus standards. For example, all of the modules may be mounted on different interconnected expansion cards or all of the modules may be mounted on one expansion card. By way of example only, the modules may interface with a motherboard or processor 102 of device 100 through an expansion slot (e.g., a peripheral component interconnect (“PCI”) slot or a PCI express slot). Alternatively, the modules may not be removable but may include one or more dedicated modules that may include memory (e.g., RAM) dedicated to the utilization of the module. Any or each module may include its own processing circuitry and/or memory. Alternatively, any or each module may share processing circuitry and/or memory with any other module and/or processor 102 and/or memory 104 of device 100.

The use of one or more suitable algorithms and/or models and/or engines and/or neural networks or the like (e.g., as may be provided by any suitable passcode management application 103) may be run by and/or executed on and/or otherwise provided by device 100 to enable the effective and efficient processing for automatic generation of one or more mnemonics by one or more frameworks for one or more potential passcodes based on one or more learning techniques and any suitable on-device information data source(s). Such processing running on any suitable processing units (e.g., graphical processing units (“GPUs”) that may be available to device 100) may provide significant speed and/or power-saving improvements in efficiency and accuracy with respect to framework defining and mnemonic definition over human-conducted handling of data, as such processing can provide recommendation(s) in a few milliseconds or less, thereby improving the functionality of any computing device on which such processing may occur. Due to such efficiency and accuracy, such processing (e.g., of process 300) enable a technical solution for enabling the definition (e.g., at operation 312) of any suitable mnemonic (e.g., for controlling the security of one or more device resources using any suitable on-device information element(s) of any suitable data source(s) made available to the computer processing that may not be possible without the use of such processing, as such processing may increase performance of their computing device(s) by requiring less memory and/or less power, providing faster response times, and/or increased accuracy and/or reliability). Due to the condensed time frame and/or the time within which a recommendation for securing a device resource may be made, such processing offers the unique ability to provide useful mnemonic recommendations for device resource security with the speed and security (e.g., on-device processing) necessary to enable a service that will be used by an electronic device user.

As described above, one aspect of the present technology is the gathering and use of data available from various specific and legitimate sources to recommend passcodes. The present disclosure contemplates that in some instances, this gathered data may include personal information data that uniquely identifies or can be used to identify a specific person. Such personal information data can include demographic data, location-based data, online identifiers, telephone numbers, email addresses, home addresses, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used to recommend passcodes with mnemonics that may be of greater interest to the user in accordance with their preferences. Accordingly, use of such personal information data enables users to have greater control of the delivered content. Further, other uses for personal information data that benefit the user are also contemplated by the present disclosure. For instance, health and fitness data may be used, in accordance with the user's preferences to provide insights into their general wellness, or may be used as positive feedback to individuals using technology to pursue wellness goals and/or to recommend passcodes with mnemonics.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominently and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of passcode and mnemonic delivery services, the present technology can be configured to allow users to select to “opt in” or “opt out” of participation in the collection of personal information data during registration for services or anytime thereafter. In another example, users can select not to provide passcode and mnemonic services based on some or all personal data. In yet another example, users can select to limit the length of time passcode and mnemonic services based on certain user data may be maintained or entirely block the development of such services. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, passcodes and/or mnemonics can be selected and delivered to users based on aggregated non-personal information data or a bare minimum amount of personal information, such as the content being handled only on the user's device or other non-personal information available to the passcode and mnemonic services. In some embodiments, any on-device data information obtained for use in passcode recommendation (e.g., at operation 310) may be limited to on-device data information that has not been shared with any remote device or made public in one or more ways (e.g., no user media playlist information may be relied on or obtained at operation 310 if such playlist information has been publicly shared off of device 100 and may be available to would be imposters).

While there have been described systems, methods, and computer-readable media for recommending passcodes for an electronic device using information local to the electronic device, it is to be understood that many changes may be made therein without departing from the spirit and scope of the subject matter described herein in any way. Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

Therefore, those skilled in the art will appreciate that the present technology can be practiced by other than the described embodiments, which are presented for purposes of illustration rather than of limitation.

What is claimed is:

1. A method for managing security of an electronic device that comprises an output component, a memory component storing a plurality of information elements of at least one data source, and a processor communicatively coupled to each one of the output component and the memory component, wherein the method comprises using the processor for:
selecting a passcode;
selecting a learning technique;
determining a framework for the selected passcode using the selected learning technique;
obtaining at least a subset of the plurality of information elements;
defining a mnemonic for the selected passcode by satisfying the determined framework using at least one information element from the obtained subset; and
presenting a passcode recommendation comprising a representation of the defined mnemonic to a user of the electronic device via the output component.

2. The method of claim 1, wherein the at least one information element comprises at least one of the following types of information elements:
a name of a song media item;
a name of an artist of a song media item;
a hometown of an artist of a song media item;
a name of a genre of a song media item;
a name of an album of a song media item;
a date of release of a song media item;
a topic of a song media item;
a name of a movie media item;
a name of an artist of a movie media item;
a location of creation of a movie media item;
a genre of a movie media item;
a date of release of a movie media item;
a subject of a photograph media item;
a geographical location of a photograph media item;
a topic of a movie media item;
a type of an event calendar item;
a date of an event calendar item;
a participant of an event calendar item;
a location of an event calendar item;
a person's name of a contact item;
a person's e-mail address of a contact item;
a person's mailing address of a contact item;
a person's telephone number of a contact item;
a person's occupation of a contact item;
a person's birthday of a contact item; or
a person's relative's name of a contact item.

3. The method of claim 1, wherein the at least one data source comprises a library of media items operative to be played back by a media application run by the processor.

4. The method of claim 3, wherein the at least one information element comprises at least a portion of a name of a media item of the library of media items.

5. The method of claim 4, wherein the media item meets at least a threshold level of popularity amongst the media items of the library.

6. The method of claim 3, wherein the at least one information element comprises at least a portion of a name of an artist of a media item of the library of media items.

7. The method of claim 6, wherein the representation comprises a picture of the artist.

8. The method of claim 3, wherein the at least one information element comprises at least a portion of a name of an album comprising a media item of the library of media items.

9. The method of claim 8, wherein the representation comprises a picture of cover art of the album.

10. The method of claim 1, wherein the at least one data source comprises a collection of contact items operative to be utilized by a contact application run by the processor.

11. The method of claim 10, wherein the at least one information element comprises at least a portion of a name of a person represented by a contact item of the collection of contact items.

12. The method of claim 11, wherein the representation comprises a picture of the person.

13. The method of claim 10, wherein the at least one information element comprises at least a portion of an address of a person represented by a contact item of the collection of contact items.

14. The method of claim 1, wherein the at least one data source comprises a collection of photographs operative to be displayed by a photograph application run by the processor.

15. The method of claim 14, wherein the at least one information element comprises at least a portion of a name of a person in a photograph of the collection of photographs.

16. The method of claim 1, further comprising, using the processor for:
receiving selection of the presented passcode recommendation from the user;
after the receiving, locking a resource on the electronic device; and
after the receiving, setting the selected passcode as a new passcode for the resource.

17. The method of claim 16, further comprising, using the processor for storing the new passcode and information indicative of the selected learning technique and information indicative of the defined mnemonic in the memory component.

18. The method of claim 16, further comprising, using the processor for:
after the setting and after the locking, detecting an unlock attempt for the locked resource; and
presenting a hint to the user via the output component, wherein the hint comprises information indicative of at least one of the selected learning technique or the representation of the defined mnemonic.

19. A method for managing security of an electronic device that comprises a processor and a memory component storing a plurality of media items operative to be played back by the processor, wherein the method comprises using the processor for:
determining a framework for a passcode using a learning technique; and
defining a mnemonic for the passcode by satisfying the framework using at least a portion of text metadata associated with at least one media item of the plurality of media items.

20. A method for managing security of an electronic device that comprises a processor and a memory component storing a plurality of information elements of at least one data source, wherein the method comprises using the processor for:
defining a mnemonic using at least one information element from the plurality of information elements;
selecting a learning technique; and
determining a passcode based on the defined mnemonic and the selected learning technique.
